(19) United States
(12) Patent Application Publication
(10) Pub. No.: US 2005/0080759 A1
(43) Pub. Date: Apr. 14, 2005

(54) TRANSPARENT INTERFACE TO A MESSAGING SYSTEM FROM A DATABASE ENGINE

(75) Inventors: Kevin Brown, San Rafael, CA (US); Susan Lynn Cline, Oakland, CA (US); Martin Siegenthaler, San Francisco, CA (US); Michael John Elvery Spicer, Lafayette, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/682,618

(22) Filed: Oct. 8, 2003

(51) Int. Cl. G06F 17/30

(52) U.S. Cl. 707/1

(57) ABSTRACT

A method, apparatus and article of manufacture, implementing the method, interfaces a messaging system to a database management system. The database management system has at least one database command to access a table. A messaging system has at least one messaging system command to access a message queue. The message queue is accessed as a table in accordance with the database command. In another embodiment, a virtual table is associated with the message queue. The message queue is accessed through the virtual table in accordance with the database command.

### BACKGROUND OF THE INVENTION

1. Field of the Invention

The invention relates to a technique, specifically a method, apparatus, and article of manufacture that implements the method, to provide a transparent interface to a messaging system from a database engine in a database management system.

2. Description of the Related Art

Database management systems allow large volumes of data to be stored and accessed efficiently and conveniently in a computer system. Referring to FIG. 1, in a database management system, data is stored in at least one database table 10 which effectively organizes the data into rows 12 and columns 14. A row 12 is also referred to as a record.

In the database management system, a database engine responds to commands to allow a user to insert data into, delete data from, or search the database tables. Conventionally, the commands are Structured Query Language (SQL) statements that conform to a Structured Query Language standard as published by the American National Standards Institute (ANSI) or the International Standards Organization (ISO).

Different organizations within a business may use different kinds of application programs from different vendors and need to exchange information among the application programs. Business integration software is typically used to interconnect the applications. To exchange information, some business integration software provides a messaging system to send messages among the different applications. For example, IBM® WebSphere® (IBM and WebSphere are Registered Trademarks of International Business Machines Corporation) Message Queue (MQ) software (formerly called MQSeries and hereinafter referred to as WebSphere MQ) uses message queues to send and receive messages among applications. WebSphere MQ encapsulates a message in a wrapper and sends the message to its destination, insuring delivery.

The messaging system software typically has a different application programming interface from the database management software. For example, the WebSphere MQ software has an Application Messaging Interface (AMI) that provides a set of AMI functions to send a message to a message queue or read a message from the message queue. The application messaging interface and AMI functions are described in the document “IBM WebSphere MQ Application Messaging Interface” 1.2.2, First Edition, March 2002. To use the application messaging interface, a software developer needs to understand the application messaging interface and the underlying WebSphere MQ software mechanism, and write code to interact with the AMI functions. In particular, the application messaging interface may require that the developer know and specify an appropriate service and policy to use. The service is a destination to which applications can send messages or from which applications can receive messages. In WebSphere MQ, the destination is a message queue. The policy controls how the AMI functions such as the message attributes, the send and receive options and the publish/subscribe options operate. For example, in the application messaging interface, a message may be sent to a queue using a series of AMI functions as follows:
amInitialize(‘ACCOUNTING.POLICY’, &CompletionCode, &Reason);
amSendMsg(hSession, ‘ACCOUNTING.SERVICE’, ‘ACCOUNTING.POLICY’, dataLen, &message, NULL, &CompletionCode, &Reason)
amTerminate(hSession, ‘ACCOUNTING.POLICY’, &CompletionCode, &Reason).
   In the exemplary AMI functions above, the service is specified by a service object called ACCOUNTING.SERVICE. The policy is specified by a policy object called ACCOUNTING.POLICY.

A database application developer typically uses SQL statements, such as INSERT and SELECT, to insert data into or select data from a table, respectively. The messaging system functions are different from the SQL statements used by a database developer. Therefore, the database application developer needs to learn the messaging system software mechanism, which increases development time, thereby increasing the cost of developing the software. In addition, having to learn and use a new unfamiliar mechanism makes the development and maintenance of the software more error-prone.

Therefore, there is a need for a technique that reduces the cost of developing software and reduces the number of errors when a database management system is interfaced to a messaging system. This technique should enable a database developer to interact with the messaging system in a manner more natural to the database application developer, and provide a transparent interface to the messaging system from the database management system.

### SUMMARY OF THE INVENTION

To overcome the limitations in the prior art described above, and to overcome other limitations that will become apparent upon reading and understanding the present specification, the present invention discloses a method, apparatus, and article of manufacture for interfacing a messaging system to a database management system.

In one aspect of the present invention, a database management system has at least one database command to access a table. A messaging system has at least one messaging system command to access a message queue. The message queue is accessed as a table in accordance with a database command.

In another more particular aspect of the invention, a virtual table is associated with the message queue. The message queue is accessed through the virtual table in accordance with a database command.

In yet another aspect of the invention, multiple message queues are accessed through the virtual table in accordance with a database command.

In this way, a transparent interface to the messaging system is provided. Because the developer accesses a message queue as a table using database commands, development time is reduced and the software has fewer errors.

### BRIEF DESCRIPTION OF THE DRAWINGS

The teachings of the present invention can be readily understood by considering the following detailed description in conjunction with the accompanying drawings, in which:

FIG. 1 depicts an exemplary table in accordance with the prior art;

FIG. 2 depicts an illustrative computer system that uses the teachings of the present invention;

FIG. 3 depicts an illustrative diagram of the binding of a virtual table to a message queue using a virtual table interface and a messaging system application programming interface (API);

FIG. 4 depicts a high-level block diagram of an exemplary messaging system interface;

FIG. 5 depicts a high-level flowchart of an embodiment of a technique to create a message queue and virtual table, in which the virtual table is bound to the message queue, and to access the virtual table to communicate with the message queue;

FIGS. 6A and 6B depict more-detailed flowcharts of an embodiment of the technique of FIG. 5 to create a message queue and virtual table, in which the virtual table is bound to the message queue;

FIG. 7 depicts a more-detailed block diagram of the queue-to-table binding information of FIG. 2;

FIG. 8 depicts an exemplary SQL statement to insert a message into a queue using a virtual table;

FIG. 9 depicts a more-detailed flowchart of an embodiment of the technique of FIG. 5 to access, and in particular, to insert a message into the message queue using a SQL INSERT statement;

FIG. 10 depicts an exemplary SQL statement to retrieve a message from a queue using a virtual table;

FIG. 11 depicts a high-level flowchart of an embodiment of the processing of a SQL SELECT statement by the database engine.

FIGS. 12A and 12B collectively depict a more-detailed flowchart of an embodiment of the ampfBeginScan( ) access method purpose function;

FIG. 13 depicts a more-detailed flowchart of an embodiment of the ampfNextRow( ) access method purpose function;

FIG. 14 depicts a more-detailed flowchart of an embodiment of the ampfEndScan( ) access method purpose function;

FIG. 15 depicts a high-level flowchart of an embodiment of a technique to create a distribution list, binding a virtual table to the distribution list, and sending a message to the message queues on the distribution list using a SQL INSERT statement;

FIGS. 16A and 16B depict more-detailed flowcharts of an embodiment of a technique to create the distribution list and virtual table, in which the virtual table is bound to the distribution list; and

FIG. 17 depicts a more-detailed flowchart of an embodiment of a technique to send a message to the message queues in a distribution list using a SQL INSERT statement.

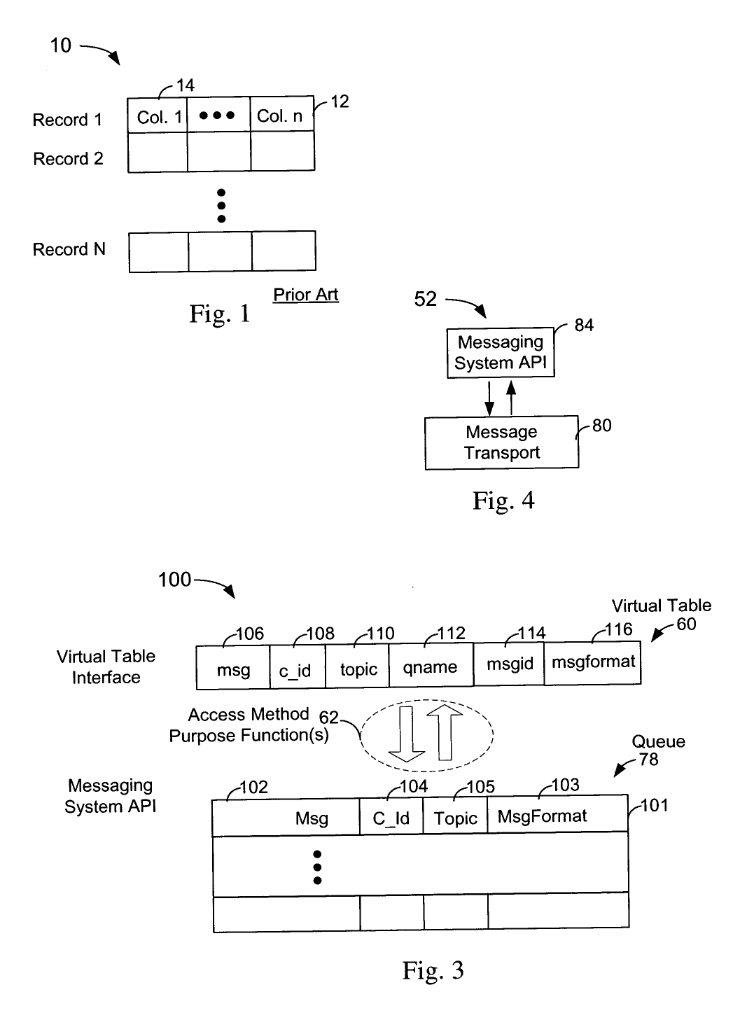

To facilitate understanding, identical reference numerals have been used, where possible, to designate identical elements that are common to some of the figures.

### DETAILED DESCRIPTION OF THE PREFERRED EMBODIMENTS

After considering the following description, those skilled in the art will clearly realize that the teachings of the present invention can be utilized with substantially any database management system with database tables, an application programming interface that provides virtual tables to databases users, and a messaging system. A virtual table presents data in a table format that enables external applications to manipulate the data. The data in a virtual table may not be completely controlled by the database management system. An external module, such as an external application, can manage the data in the virtual table. The external module presents and accepts data when requested by a database engine.

A technique provides a database interface to a messaging system. In one embodiment, the technique accesses a message queue as a table from a database management system. In a more particular embodiment, a virtual table is associated with the message queue, and the message queue is accessed as a virtual table. In this way, a subset of the database commands that access a table are used to access the message queue.

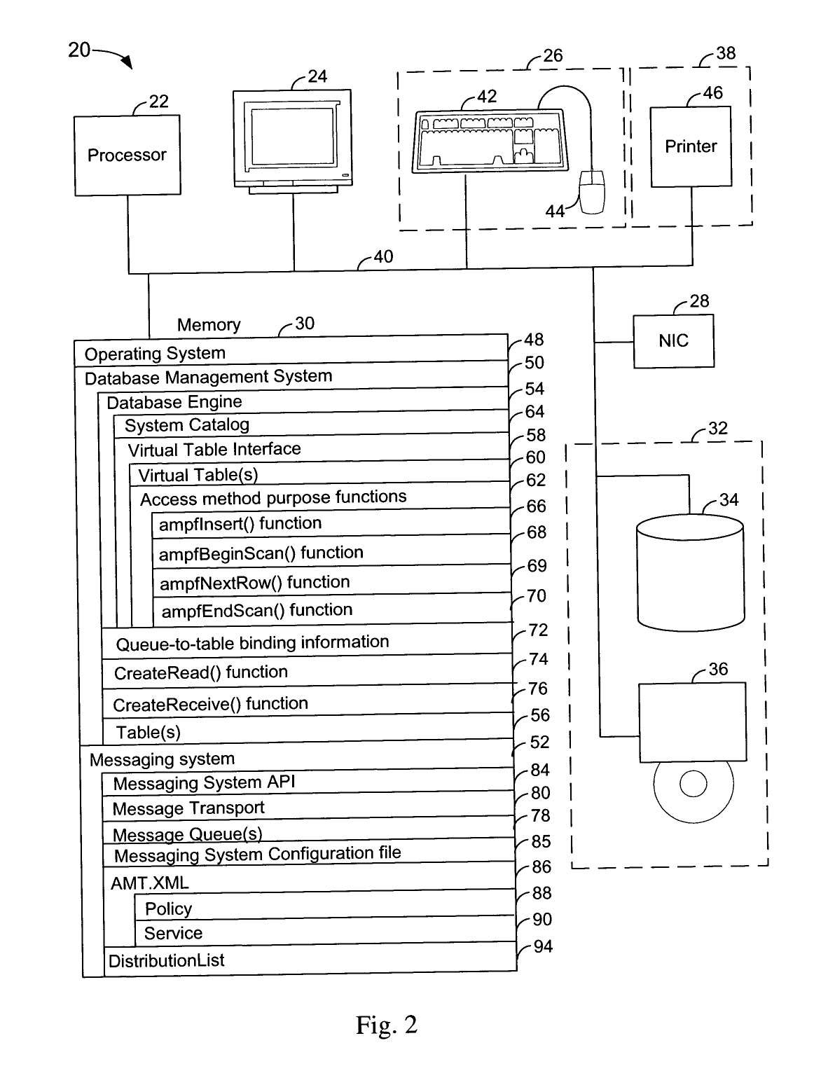

FIG. 2 depicts an illustrative computer system 20 that utilizes the teachings of the present invention. The computer system 20 comprises a processor 22, display 24, input interfaces (I/F) 26, communications interface 28, memory 30, disk memories 32 such as hard disk drive 34 and optical disk drive 36, and output interface(s) 38, all conventionally coupled by one or more busses 40. The input interfaces 26 have a keyboard 42 and mouse 44. The output interface 38 is a printer 46. The communications interface 28 is a network interface card (NIC) that allows the computer 20 to communicate via a network, such as the Internet.

The memory 30 generally comprises different modalities, illustratively semiconductor memory, such as random access memory (RAM), and disk drives. The memory 30 stores operating system (O/S) 48 and application programs such as the database management system 50 and the messaging system 52. The O/S 48 may be implemented by any conventional operating system, such as AIX® (Registered Trademark of International Business Machines Corporation), UNIX® (UNIX is a registered trademark in the United States and other countries licensed exclusively through X/Open Company Limited), LINUX® (Registered trademark of Linus Torvalds), and WINDOWS® (Registered Trademark of Microsoft Corporation).

The database management system 50 is an IBM Informix Dynamic Server database management system. Alternately, the database management system 50 is an IBM Cloudscape database management system. However, the inventive technique is not meant to be limited to an IBM Informix Dynamic Server or a Cloudscape database management system, and may be used with other database management systems.

In one embodiment, the messaging system 52 is WebSphere MQ. However, the inventive technique is not meant to be limited to WebSphere MQ, and may be used with other messaging systems.

A database engine 54 allows a user to execute commands to insert data into, delete data from, or search the database tables. In one embodiment, the commands are Structured Query Language (SQL) statements that conform to a Structured Query Language standard as published by the American National Standards Institute (ANSI) or the International Standards Organization (ISO). In an alternate embodiment, SQLJ may be used. In other alternate embodiments, languages other than SQL and SQLJ may be used.

Generally, the database management system 50 and messaging system 52 software are tangibly embodied in a computer-readable medium, for example, memory 30 or, more specifically, one of the disk drives 32, and are comprised of instructions which, when executed, by the processor 22, cause the computer system 20 to utilize the present invention.

In the memory 30, the database management system 50 and the messaging system 52 are comprised of software modules and data. A software module may comprise one or more computer programs. In some embodiments, the computer programs may comprise one or more functions. In one embodiment, the memory 30 may store a portion of the software modules and data, while other software modules and data are stored in disk memory. In some embodiments, the memory 30 stores the following:
the Operating System 48;
the Database Management System 50 comprising:
   at least one Table 56 to store data;
   a Database Engine 54 that receives a SQL statement and accesses one or more tables 56 of the database in accordance with the SQL statement;
   a Virtual Table Interface (VTI) 58 that allows a user to create a virtual table 60 and add access method purpose functions 62 that are invoked when the virtual table 60 is accessed;
   a System Catalog 64 that stores a mapping of generic to actual access method purpose functions 62;
   Access method purpose functions 62 including, and not limited to, the following:
      an ampfInsert( ) function 66 that is invoked when a SQL INSERT statement is used to access the virtual table 60;
      an ampfBeginScan( ) function 68 that is invoked when a SQL SELECT statement is used to initially access the virtual table 60; an ampfNextRow( ) function 69 that is invoked in response to the SQL SELECT statement; and
      an ampfEndScan( ) function 70 that is invoked in response to the SQL SELECT statement;
   Queue-to-table binding information 72 that associates a virtual table with at least one messaging system parameter;
   a CreateRead( ) function 74 to bind a queue to a virtual table such that non-destructive reads will be performed against the queue;
   a CreateReceive( ) function 76 to bind a queue to a virtual table such that destructive reads will be performed against the queue; and
      the Messaging System 52 comprising:
   one or more Message Queues 78 to send and receive messages between applications;
   Message Transport 80 to interface with the message queues 78;
   a Messaging System Application Programming Interface 84 to provide an interface to the messaging system 52 and the message transport 80;
   a Messaging System Configuration file 85 that specifies the destination queue(s) to which applications can send messages and from which applications can receive messages, and how the queues operate; In one embodiment, using the application messaging interface of WebSphere MQ, an AMT.XML file 86 acts as a messaging system configuration file that specifies the details of the service(s) 88 and policy(ies) 90 used to access respective message queue(s) 78; and
   a Distribution List 94 that specifies multiple queues to which to send a message.

In one embodiment, the database engine is the IBM Informix Dynamic Server and has a DataBlade application programming interface. The DataBlade API is described in the “IBM Informix DataBlade API Programmer's Manual, UNIX, Linux, and Windows,” Version 9.3, August 2001. The virtual table interface 58 is described in the “Virtual-Table Interface Programmer's Manual”, Version 9.2, September 1999, published by Informix Press. However, the invention may be used with other database engines and virtual table interfaces.

In another embodiment, the messaging system application programming interface 84 is the WebSphere MQ Application Messaging Interface. Alternately, the messaging system application programming interface 84 is the Java® Messaging Service (JMS) (Java is a registered trademark of Sun Microsystems, Inc.). However, the messaging system application programming interface 84 is not meant to be limited to the WebSphere MQ Application Messaging Interface or Java Messaging Service, and may be implemented with other messaging system application programming interfaces.

The present invention may be implemented as a method, apparatus, or article of manufacture using standard programming and/or engineering techniques to produce software, firmware, hardware, or any combination thereof. The term “article of manufacture” (or alternately, “computer program product”) as used herein is intended to encompass a computer program accessible from any computer-readable device, carrier, or media. Those skilled in the art will recognize that many modifications may be made to this configuration without departing from the scope of the present invention.

Those skilled in the art will recognize that the exemplary computer illustrated in FIG. 2 is not intended to limit the present invention. Indeed, those skilled in the art will recognize that other alternative hardware environments may be used without departing from the scope of the present invention.

In one embodiment, the technique provides a table interface to a message queue. The table interface allows a message to be added to the message queue with a SQL INSERT statement. The table interface also allows a message to be removed or read from a message queue with a SQL SELECT statement. The SQL INSERT and SELECT statements are well-known to database application developers.

FIG. 3 depicts an illustrative diagram 100 of the binding of a virtual table 60 to a message queue 78. In the messaging system, the message queue 78, specified by the queue name, stores messages 101 comprising message data (Msg) 102, and a specified message format (MsgFormat) 103.

In an alternate embodiment, a correlation identifier (C_Id) 104 is associated with the message 101. The correlation identifier 104 is an optional attribute of a message 101. If a correlation identifier 104 is specified, the correlation identifier 104 will be added to the message 101. Messages can be retrieved from the queue based upon their correlation identifier 104 to allow an application to selectively retrieve messages from the queue.

In another alternate embodiment, a topic (Topic) 105 is associated with the message 101. The topic 105 is an optional attribute of a message 101. If a topic is specified, then the topic 105 will be added to the message 101 in the message queue 78. Topics are used in Publish/Subscribe applications in which multiple applications subscribe to a topic and a single application publishes to the same topic. The underlying queuing system is responsible for duplicating the published messages and distributing the messages to the subscribers.

Referring also to FIG. 2, the technique utilizes the IBM Informix Dynamic Server's Virtual Table Interface (VTI) 58 in the database engine to bind the virtual table 60 to the message queue 78. The virtual table 60 presents table data in memory. The virtual table interface 58 does not physically store data in the tables 56 in the database management system. The database engine invokes access method purpose functions 62, which are bound functions that interface the virtual table 60 to the message queue 78 using the messaging system API. The access method purpose functions 62 are invoked in response to specified SQL statements that access the virtual table 60.

In one embodiment, the virtual table 60 has the following columns: message data (msg) 106, correlation identifier (c_id) 108, topic 110, queue name (qname) 112, message identifier (msgid) 114 and message format (msgformat) 116. The message data column 106 contains the message data to be sent or that was read. The message identifier 116 is typically unique and may be generated by the messaging system. The correlation identifier 108 may be used as a key to correlate a response message with a request message. In one embodiment, the correlation identifier 108 is set equal to the message identifier of the request message. The message format 116 specifies the structure of the message. The topic 110 indicates the content of the message for Publish/Subscribe applications. The queue name 112 indicates the name of the queue from which a message was read or received.

FIG. 4 depicts a high-level block diagram of an exemplary messaging system. In the messaging system, a messaging system API 84 communicates with a lower level message transport 80 that interfaces with the message queues.

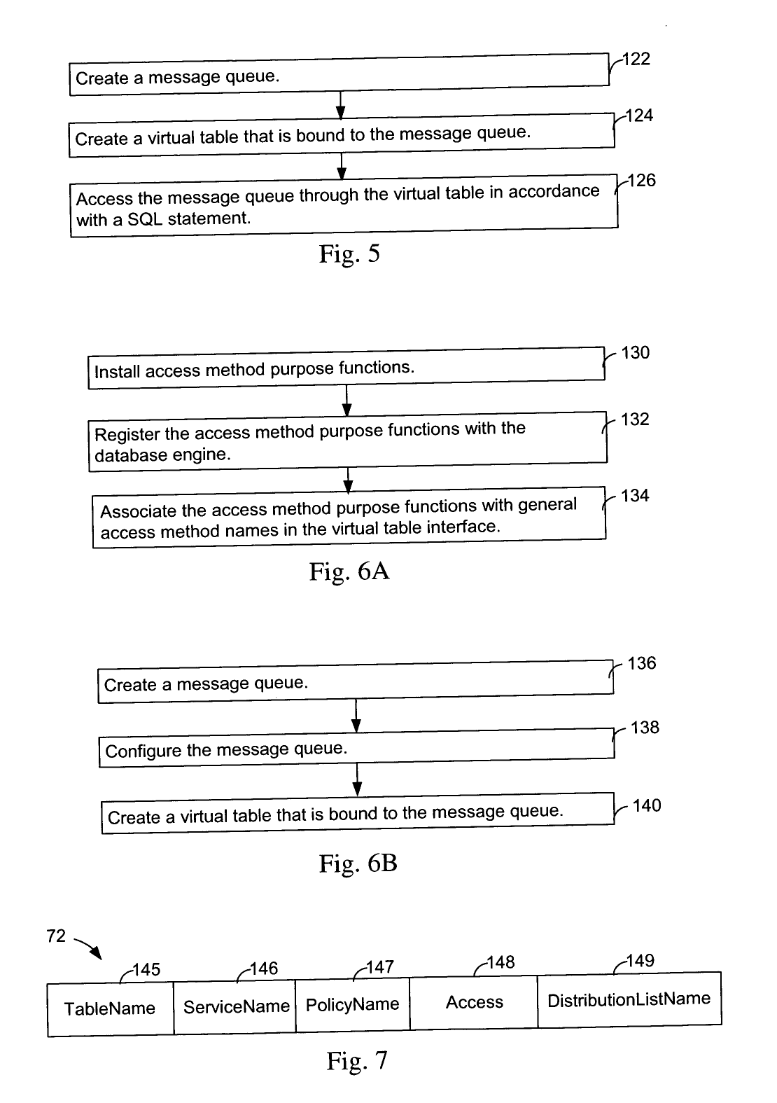

FIG. 5 depicts a high-level flowchart of an embodiment of a technique to create a message queue and virtual table, then access the message queue through the virtual table. In step 122, a message queue is created. Creating a message queue is well-known and will not be further described. In step 124, a virtual table that is bound to the message queue is created. In step 126, the message queue is accessed through the virtual table in accordance with a SQL statement.

FIGS. 6A and 6B depict two flowcharts of an embodiment of a technique to create a message queue and a virtual table that is bound to the message queue. In one exemplary embodiment, the messaging system has the following components: IBM WebSphere MQ, the WebSphere MQ application messaging interface and optionally the WebSphere MQ Publish/Subscribe software.

In FIG. 6A, the access method purpose functions are installed and the virtual table interface is configured. The steps of FIG. 6A are typically performed once; however, the steps of FIG. 6A may be repeated. In another embodiment, the steps of FIG. 6A are performed by an installation script.

In step 130, the access method purpose functions that are utilized by the virtual table interface are installed. The access method purpose functions are written and compiled prior to installation by a database developer. The access method purpose functions communicate with the message queues via the messaging system application programming interface and will be described in further detail below.

In step 132, the access method purpose functions are registered with the database engine. The access method purpose functions fulfill the database engine's request to accept data from and present data to the virtual table interface. In one exemplary embodiment, a SQL CREATE FUNCTION statement registers the access method purpose functions with the database engine. The SQL CREATE FUNCTION statements for four exemplary access method purpose functions, called ampfInsert( ), ampfBeginScan( ), ampfNextRow( ) and ampfEndScan( ) are as follows:

```
CREATE FUNCTION ampfInsert(tableDesc POINTER, rowPTR
POINTER, *rowId INT)
    RETURNING int;
    EXTERNAL NAME “$INFORMIXDIR/extend/mymethod/
            mymethod.bld(ampfInsert)”;
    LANGUAGE C;
    END FUNCTION
CREATE FUNCTION ampfBeginScan(scanDesc POINTER)
    RETURNING int
    EXTERNAL NAME “$INFORMIXDIR/extend/mymethod/
            mymethod.bld(ampfBeginScan)”;
    LANGUAGE C;
    END FUNCTION
CREATE FUNCTION ampfNextRow (scanDesc POINTER)
    RETURNING int
    EXTERNAL NAME “$INFORMIXDIR/extend/mymethod/
            mymethod.bld(ampftNextRow)”;
    LANGUAGE C;
    END FUNCTION
CREATE FUNCTION ampfEndScan(scanDesc POINTER)
    RETURNING int
    EXTERNAL NAME “$INFORMIXDIR/extend/mymethod/
            mymethod.bld(ampfEndScan)”;
    LANGUAGE C;
    END FUNCTION
```

In step 134, the access method purpose functions are associated with general access method names in the virtual table interface, and also with a specific name. In one embodiment, a SQL statement is executed to specify the access method purpose functions that will be invoked when the virtual table is accessed. In a more particular embodiment, a SQL CREATE PRIMARY ACCESS_METHOD statement of the virtual table interface is executed. An exemplary CREATE PRIMARY ACCESS_METHOD statement associates a set of access method purpose functions with general access method names, and also with the specific name of “table-queue-purpose-functions,” as follows:

CREATE PRIMARY ACCESS_METHOD table-queue-purpose-functions

```
(
    am_insert = ampfInsert
    am_beginscan = ampfBeginScan
    am_nextrow = ampfNextRow
    am_endscan = ampfEndScan
)
```

In the CREATE PRIMARY ACCESS_METHOD statement above, a general access method function name of the virtual table interface, such as am_insert, is associated with the ampfInsert( ) access method purpose function. The virtual table interface will invoke the am_insert function, and thereby, the ampfInsert( ) access method purpose function, when a SQL INSERT statement is received.

In one embodiment, the access method purpose functions are written in the C language. Alternately, the invention is not meant to be limited to the C language, and other languages may be used.

In FIG. 6B, a message queue is created, configured and bound to a virtual table. The steps of FIG. 6B may be performed multiple times to bind multiple message queues to multiple virtual tables. In step 136, the messaging system administrator creates a message queue. In step 138, the messaging system administrator configures the message queue by updating the messaging system configuration file. In one embodiment, using WebSphere MQ, the messaging system administrator updates an AMI configuration file, referred to as AMT.XML, to specify the services and policies that the application will use to interact with the queue. The messaging system administrator sets a number of values in the AMT.XML file. An MQ receive timeout value is specified for all policies to read messages from the message queue. In one embodiment, the policy used to receive messages has the “Receive”/“Wait Interval” set equal to zero to force a queue read to return immediately if no messages are available on the queue. In an alternate embodiment, the “Receive”/“Wait Interval” has a non-zero value.

Using WebSphere MQ, the messaging system administrator specifies a service and policy for each message queue in the AMT.XML file. For example, for one message queue, a service called ACCOUNTING.SERVICE and a policy called ACCOUNTING.POLICY are specified. In an alternate embodiment, if no service or policy is specified a default service and policy will be used.

The messaging system administrator then provides information about the message queue to the database administrator. In one embodiment using WebSphere MQ, after a message queue is created and the services and policies are specified, the messaging system administrator provides the names of the services and policies that are available for use to the database administrator.

In step 140, the database administrator executes a CreateRead( ) function to create a virtual table that is bound to the message queue. The CreateRead( ) function specifies the name of the virtual table (table name) and at least one messaging system configuration parameter as follows:
CreateRead(table name, messaging system parameters).

For example, in an embodiment using the application messaging interface of WebSphere MQ, the database administrator executes the CreateRead( ) function to create a virtual table named ACCOUNTING.QUEUE that is bound to a message queue, by executing the CreateRead( ) function as follows:
execute function CreateRead (‘ACCOUNTING.QUEUE’, ‘ACCOUNTING.SERVICE’, ‘ACCOUNTING.POLICY’).
   In the CreateRead( ) function above, the messaging system parameters comprise the service name, ACCOUNTING.SERVICE, and policy name, ACCOUNTING.POLICY. The messaging system parameters are used to bind the virtual table to the message queue.

The virtual table interface is created such that the general access method functions, and therefore the associated access method purpose functions will be invoked in response to certain SQL statements. In addition, when the virtual table is created, at least one messaging system parameter is associated with the virtual table and passed as an access-method-purpose-function parameter to the access method purpose functions to bind the virtual table to a message queue. The access-method-purpose-function parameters can be retrieved by the access method purpose functions using built-in functions of the database management system. In one embodiment, at least a subset of the access-method-purpose-function parameters are used to obtain message queue configuration information from the messaging system configuration file. In another embodiment, the access-method-purpose-function parameters further comprise an access parameter that indicates the type of read that will be performed. In particular, the access parameter specifies whether a destructive or non-destructive read will be performed. For a virtual table created with the CreateRead( ) function, the access parameter is set to READ_TABLE. In one embodiment, the CreateRead( ) function creates the virtual table using a SQL CREATE TABLE statement and the table is associated with the access method purpose functions that were specified in the CREATE PRIMARY ACCESS_METHOD statement. For example, a virtual table called ACCOUNTING.QUEUE is created as follows:

CREATE TABLE ACCOUNTING.QUEUE

```
(
    msg lvarchar,
    correlid varchar(24),
    topic varchar (40),
    qname varchar (48),
    msgid varchar (12),
    msgformat varchar (8)
)
    USING table-queue-purpose-functions
        (service=ACCOUNTING.SERVICE,
        policy=ACCOUNTING.POLICY,
        access=READ_TABLE)
```

In the above example, the messaging system parameters called ACCOUNTING.SERVICE and ACCOUNTING.POLICY, and READ_TABLE are passed as the service, policy and access parameters, respectively, of the access-method-purpose-function parameters. Upon successful completion, the virtual table, ACCOUNTING.QUEUE, will have the following schema:

```
ACCOUNTING.QUEUE (
    msg lvarchar,
    correlid varchar(24),
    topic varchar (40),
    qname varchar (48),
    msgid varchar (12),
    msgformat varchar (8));
```

In one embodiment, each virtual table that provides an interface to the messaging system has the above schema. Alternately, the virtual tables may use different schemas.

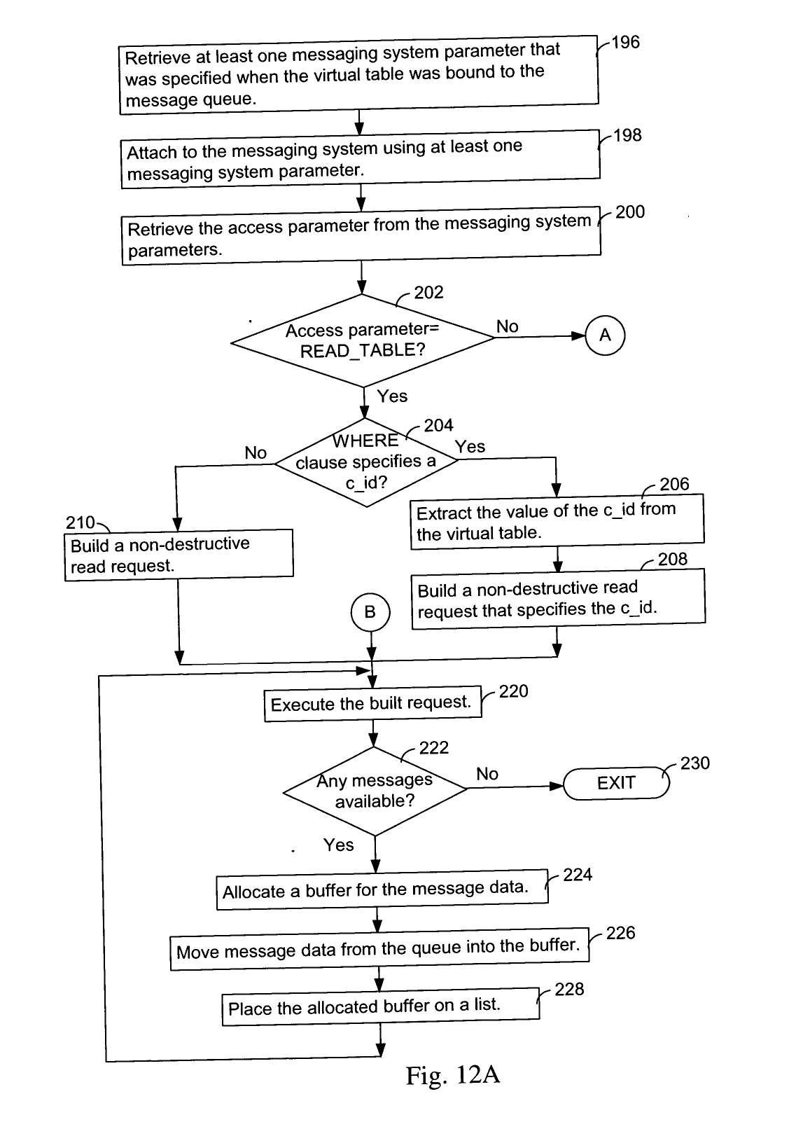

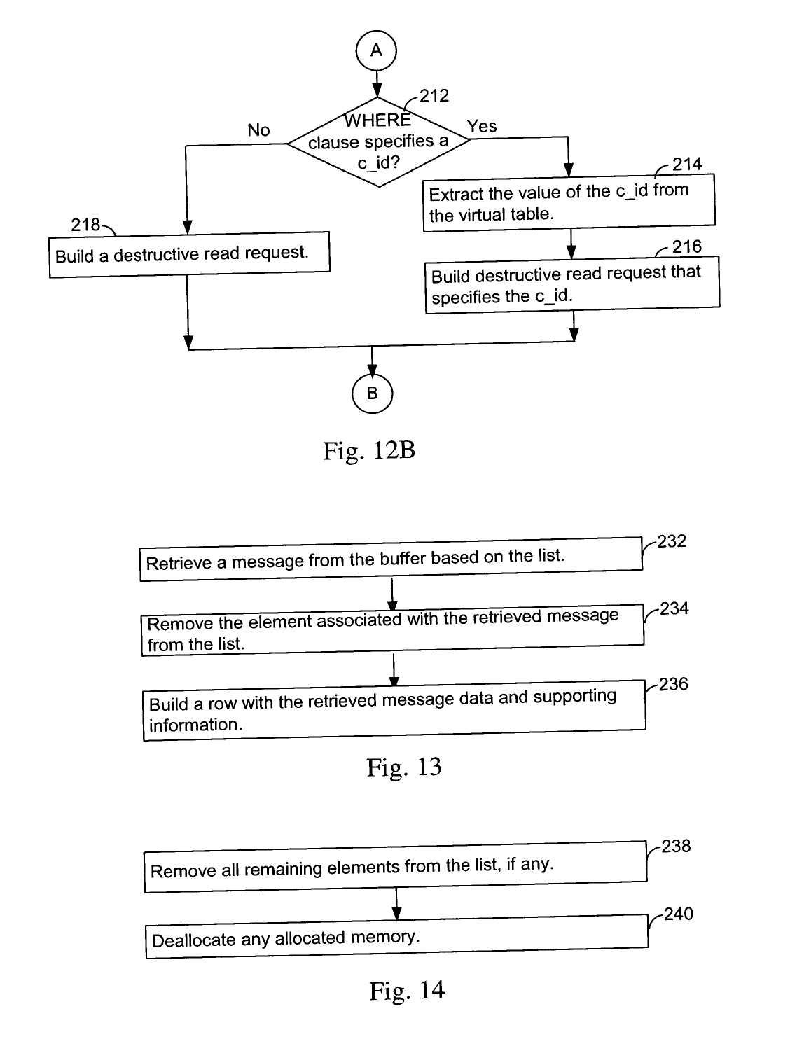

Referring also to FIG. 7, in one embodiment, the access-method-purpose-function parameters are stored as Queue-to-table binding information 72 in memory managed by the database. The queue-to-table binding information 72 comprises the service, policy and access parameters associated with the name of the virtual table. The Queue-to-table binding information 72 associates the name of a virtual table (TableName) 145, with the service name (ServiceName) parameter 146, the policy name (PolicyName) parameter 147 and the access parameter (Access) 148. In an another embodiment, which will be explained in further detail below with respect to FIGS. 12 and 13B, a distribution list name (DistributionListName) parameter 149 is also supplied as a messaging system parameter which is passed as an access-method-purpose-function parameter and associated with the virtual table 146.

When the CreateRead( ) function is used to bind a table to a message queue, subsequent SELECT statements to read the contents of the queue will perform a non-destructive read. The CreateRead( ) function causes READ_TABLE to be specified as the access parameter. For example, selecting from the ACCOUNTING.QUEUE table will retrieve messages from the message queue and return the messages in the above schema. Messages retrieved from the message queue associated with the ACCOUNTING.QUEUE table will not be removed from the message queue because the access parameter is equal to READ_TABLE.

In an alternate embodiment, the database administrator may execute a CreateReceive( ) function to create a virtual table and establish a binding between the specified virtual table name and a message queue, in accordance with specified messaging system parameters as follows:
CreateReceive(table name, messaging system parameters).

An exemplary CreateReceive( ) function which creates a virtual table called ACCOUNTING.QUEUE is as follows:
execute function CreateReceive (‘ACCOUNTING.QUEUE’, ‘ACCOUNTING.SERVICE’, ‘ACCOUNTING.POLICY’).

The CreateReceive( ) function is similar to the CreateRead( ) function except that the access parameter, that is specified and passed in the CREATE TABLE statement, is set to RECEIVE_TABLE. When the CreateReceive( ) function is used to bind a virtual table to a message queue, subsequent SELECT statements to read from the message queue will perform a destructive read of the contents of the queue, that is, the messages will be deleted from the queue.

The mapping between a bound table and its associated queue uses a functional translation that depends on the table operation. When a user accesses the virtual table in accordance with certain SQL statements, in this case an INSERT or a SELECT, the virtual table interface of the database engine invokes an access method purpose function. In this way, the access method purpose functions associated with the table ACCOUNTING.QUEUE will be invoked when an INSERT or SELECT statement is executed.

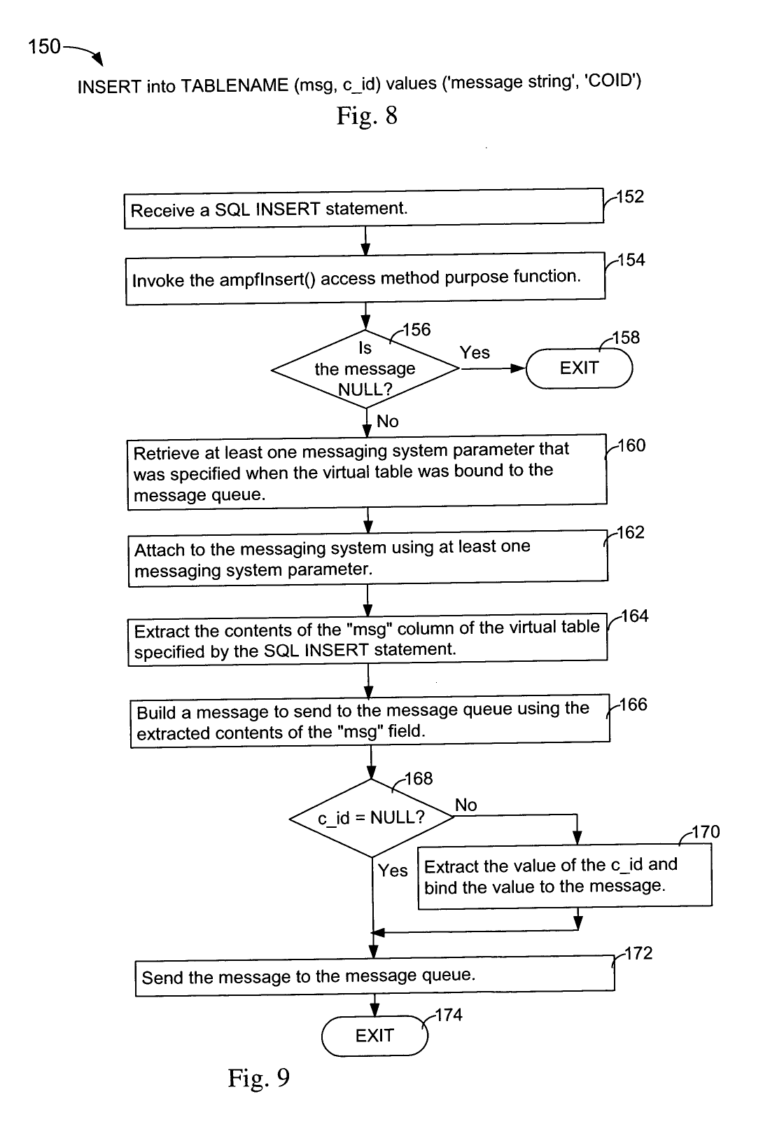

FIG. 8 depicts an exemplary SQL INSERT statement 150 to write a message to a message queue using a virtual table. The SQL INSERT statement specifies the name of the virtual table in TABLENAME, and contains a message called “message string” in the msg column and a correlation identifier called “COID” in the c_id column. Alternately, no correlation identifier is specified in the INSERT statement. For example, an INSERT statement may write a message into the message column (msg) of ACCOUNTING.QUEUE with a value of ‘Sold unit 1432 for $5,000’ as follows:
INSERT into ACCOUNTING.QUEUE(msg) values (‘Sold unit 1432 for $5,000’);

FIG. 9 depicts a more-detailed flowchart of an embodiment of a technique to access, and in particular, to insert a message into, the message queue using a SQL INSERT statement. In step 152, the database engine receives a SQL INSERT statement, for example, as shown in FIG. 8. The database engine activates the virtual table interface because the SQL INSERT statement is accessing a virtual table. The database engine also invokes the appropriate access method purpose function. In particular, when a SQL statement for a virtual table is received, the database engine looks in the system catalog and executes the access method purpose function that is specified in that catalog for that SQL statement. For each access method purpose function that is registered with the virtual table interface, as described above with respect to FIG. 6A, the system catalog has a mapping from a generic access method function name to the actual access method purpose function as specified in the CREATE PRIMARY ACCESS_METHOD statement.

In step 154, the virtual table interface invokes the ampfInsert( ) access method purpose function. The virtual table interface has descriptors to store information, and the descriptors are passed to the access method purpose functions. When the database engine invokes an access method purpose function, the database engine passes at least one descriptor of the appropriate type, populated with information for the access method purpose function. Some exemplary descriptors of the virtual table interface are a table descriptor, a row descriptor and a scan descriptor.

For example, for the ampfInsert( ) access method purpose function, the database engine will pass a reference to a table descriptor, a row descriptor and a row identifier. The message data in the message column of the virtual table can be extracted based on the table descriptor, row descriptor and row identifier. In addition, the access-method-purpose-function parameters that were specified when the virtual table was created, are made available for retrieval.

Steps 156-174 are performed by the ampfInsert( ) access method purpose function. In step 156, the ampfInsert( ) access method purpose function determines whether the INSERT statement contained a message with data, that is, whether the message is NULL. If so, in step 158, the ampfInsert( ) access method purpose function exits and returns an appropriate return value.

If not NULL, that is, if the INSERT statement contained a message with data, in step 160, at least one messaging system parameter that was passed as an access-method-purpose-function parameter, is retrieved. If no messaging system parameters can be retrieved, default values will be used. In particular, in one embodiment, the ampfInsert( ) access method purpose function retrieves the service name and the policy name that were passed as access-method-purpose-function parameters. Because the service name and the policy name were specified as access-method-purpose-function parameters when the virtual table was bound to the message queue, a built-in function in the virtual table interface can be used to retrieve the service name and the policy name.

In step 162, the ampfInsert( ) access method purpose function attaches to the messaging system based on at least one messaging system parameter. In one embodiment, using the application messaging interface of WebSphere MQ, the messaging system creates policy and service objects based on the policy and service names, respectively. In particular, the ampfInsert( ) access method purpose function invokes application messaging interface functions to create a session, a service object, a policy object, and a message object as follows:
hSession=amSesCreate (NULL, &completion-code, &reason);
hPolicy=amSesCreatePolicy(hSession, PolicyName, &completion-code, &reason)
hService=amSesCreateSender(hSession, ServiceName, &completion-code, &reason)
hMessage=amSesCreateMessage(hSession, MessageName, &CompletionCode, &Reason).
   The amSesCreate function creates a session and system default objects. The amSesCreate function returns a session handle, hSession, which is used by other function calls in this session. Pointers to a completion code and reason are also returned for error processing. The amSesCreatePolicy function creates a policy object and returns a policy handle, hPolicy. In the amSesCreatePolicy function, the session handle returned by the amSesCreate command and the name of the policy (PolicyName) are input. If the name of the policy matches a policy defined in the repository, the AMT.XML file, the policy object will be created using the repository definition, otherwise the policy object will be created with default values. The amSesCreateSender function creates a service object and returns a handle to the service object, hService. In the amSesCreateSender function, the session handle returned by the amSesCreate command and the name of the service (ServiceName) are input. If the name of the service matches a service defined in the repository, the AMT.XML file, the service object will be created using the repository definition, otherwise the service will be created with default values. In an alternate embodiment, no service or policy is specified and default values are used.

The amSesCreateMessage function creates a message object and returns a message handle, hMessage. The MessageName can be any name that is meaningful to the application.

In step 164, the ampfInsert( ) access method purpose function extracts the contents of the message (msg) column of the virtual table specified by the SQL INSERT statement. In particular, the ampfInsert( ) access method purpose function extracts the contents of the message column of the virtual table and stores the message in memory and into the queue.

For example, pseudo-code illustrating the extraction of the message data from the message (msg) column of the virtual table is shown below. The psuedo-code uses built-in functions of the virtual table interface to extract the message data. In the pseudo-code, the term, “MESSAGE_COLNAME”, refers to the column named “msg”. At the end of the pseudo-code, a pointer, called dataptr, provides a reference to the message data.

```
/* tdPtr is a pointer to the table descriptor, */
/* rowPtr is a pointer to the row; and */
/* ridPtr is a pointer to the row identifier. */
/* the tdPtr contains a reference to the msg column. */
  rowDesc = mi_tab_rowdesc(tableDesc); /* Get the row descriptor
  colCount = mi_column_count(rowDesc); /* Get the column count
/* check the column names to see if it contains the message column
name */
    for (i=0; i != colCount; i++) {
      colName = mi_column_name(rowDesc, i);
      if (strlowcmp(colName, MESSAGE_COLNAME) == 0) {
        dataIdx = i;
        continue;
      }
/* Retrieve the message data from the column of the row of the virtual
table */
comp = mi_value(row, dataIdx, &retBuf, &retLen);
  dataPtr = mi_Ivarchar_to_string((mi_Ivarchar *)retBuf);
/* dataPtr points to the string message data */
```

In step 166, the ampfInsert( ) access method purpose function builds a message to write the message data to the message queue. In one embodiment, a message object stores the message data. Application messaging interface functions are invoked to populate the message object as follows:
amMsgSetDataOffset (hMessage, offset, &CompletionCode, &Reason)
amMsgWriteBytes (hMessage, writeLen, dataPtr, &CompletionCode, &Reason).
   The amMsgSetDataOffset function sets a data offset for reading from or writing byte data to the Message Object specified by the handle, hMessage. The amMsgWriteBytes function writes the specified number of data bytes from the message data, specified by dataPtr, into the message object that is specified by the handle, hMessage, starting at the data offset. In this way, messages can be constructed in a non-sequential manner.

Step 168 determines whether the correlation identifier (c_id) column has a NULL value. If not, in step 170, the ampfInsert( ) access method purpose function extracts the value of the correlation identifier from the table descriptor. The ampfInsert( ) access method purpose function sets the correlation identifier to be sent as follows:
amMsgSetCorrelId(hMessage, correlIdLen, &cor_id, &CompCode, &Reason).

The parameter, correlIdLen, specifies the length of the correlation identifier. The parameter, cor_id, specifies a pointer to the value of the correlation identifier. The function then proceeds to step 172.

If step 168 determines that the correlation identifier has a NULL value, the message is ready to be written to the queue. In step 172, the ampfInsert( ) access method purpose function inserts or writes the message to the queue. In one embodiment using the application messaging interface, an amSndSend( ) function is used to write the message to the queue as follows:

| | | |
|---|---|---|
| success=amSndSend | | |
| (hSession, | /*Session handle from the | */ |
| | amInitialize | |
| hService, | /*Service object | */ |
| hPolicy, | /*Policy object | */ |
| AMH_NULL_HANDLE | /*For a response message, the | */ |
| | /*handler of the receiver service to | */ |
| | /*which the response to this | */ |
| | message should be sent | |
| messageLen | /*Length of the message data, if | */ |
| | /*equal to 0, any message data | */ |
| | /*will be passed in | |
| | /*the Message Object | */ |
| Message | /*Message string | */ |
| hMessage | /*Message Object specifying the | */ |
| | /*properties of the message | */ |
| &compCode, | /* Completion Code | */ |
| &reason); | /* Reason | */ |

The amSndSend function sends the message to the destination specified by the service object handle, hService. The message data can be passed in the message object or as separate parameter. In this embodiment, the message length is set equal to zero and the message data is passed via the Message Object. Alternately, the message data is passed via the Message argument and the message length is set equal to the length of the message being passed in the message argument.

In step 174, the ampfInsert( ) access method purpose function closes and deletes the session using the amSesDelete function of the application messaging interface as follows:
success=amSesDelete (&hsession, &completion-code, &reason).
   The ampfInsert( ) access method purpose function ends.

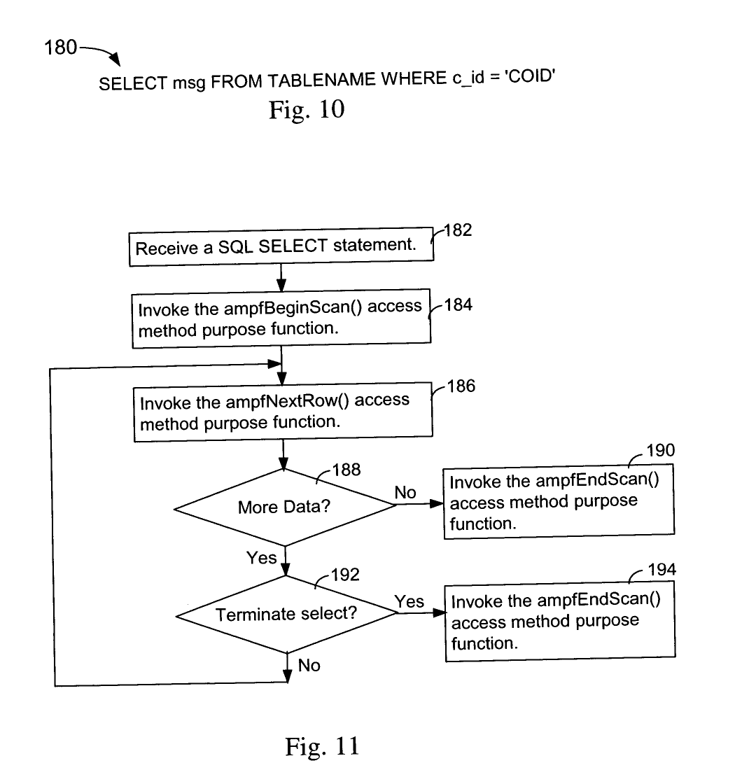

FIG. 10 depicts an exemplary SQL SELECT statement 180 to read a message from a message queue using a virtual table called TABLENAME. The message is returned in the msg column of TABLENAME. In the SQL statement of FIG. 10, a correlation identifier c_id having a value of “COID” is specified. Alternately, no correlation identifier is specified. Additional exemplary SQL SELECT statements to read or retrieve messages from the message queue, depending on the configuration, are shown below:
SELECT msg FROM TABLENAME
SELECT*FROM TABLENAME

FIG. 11 depicts a high-level flowchart of an embodiment of the processing of a SQL SELECT statement by the database engine. In step 182, the database engine receives a SQL SELECT statement. In step 184, the database engine invokes the ampfBeginScan( ) access method purpose function to retrieve the message data from the message queue and place the message data into a buffer. In step 186, the database engine invokes the ampfNextRow( ) access method purpose function to retrieve message data from the buffer and place the message data in the virtual table. In step 188, the database engine determines whether there is more data to retrieve. If not, in step 190, the database engine invokes the ampfEndScan( ) access method purpose function. If step 188 determines that there is more data to retrieve, in step 192, the database engine determines whether the SELECT is to be terminated. For example, a user may issue a break or a stop. If so, in step 194, the database engine invokes the ampfEndScan( ) access method purpose function to free up the buffer and memory. If step 192 determines that the SELECT is not to be terminated, the database engine proceeds back to step 186.

FIGS. 12A and 12B collectively depict a more-detailed flowchart of an embodiment of the ampfBeginScan( ) access method purpose function which is invoked in FIG. 11. In step 196, the ampfBeginScan( ) access method purpose function retrieves at least one messaging system parameter that was passed as access-method-purpose-function parameter. In one embodiment, the messaging system parameters comprise the service and policy names as described above with respect to step 160 of FIG. 8. In step 198, the ampfBeginScan( ) access method purpose function attaches to the messaging system using at least one of the retrieved messaging system parameters. In one embodiment, the ampfBeginScan( ) access method purpose function attaches to the messaging system using the policy and service names to create policy and service objects, respectively, as described above with respect to step 162 of FIG. 8.

In step 200, the access parameter is retrieved. Step 202 determines whether the value of the access parameter is equal to “READ_TABLE.” If the access parameter matches “READ_TABLE” a non-destructive read of the message queue will be performed. In step 204, if the SQL SELECT statement specified a correlation identifier (c_id) in a WHERE clause, in step 206, the value of the correlation identifier is extracted from the message. In step 208, a non-destructive read request is built. In one embodiment, an application messaging interface RcvBrowseSelect request is built. The correlation identifier is optional. An exemplary amRcvBrowseSelect function, with a correlation identifier which is evaluated, is as follows:

| | | |
|---|---|---|
| success=amRcvBrowseSelect ( | | |
| hService, | /*Service object handle | */ |
| | /*returned by the | */ |
| | amSesCreateReceiver function | |
| hPolicy, | /* Policy object handle, if | */ |
| | specified as | |
| | /*AMH_NULL_HANDLE, the | */ |
| | system | |
| | /*default policy is used. | */ |
| AMBRW_NEXT, | /*Options to control the browse | */ |

(amContext->corrldStr[0]!=0)?amContext->hMsg : NULL

| | | |
|---|---|---|
| 0, | /*Length of buffer in which data | */ |
| | /*returned | */ |
| NULL, | /*Length of message | */ |
| NULL, | /* Message | */ |
| amContext->hMessage, | /*Receive Message handle | */ |
| NULL, | /*Handle of message object for the | */ |
| | /*received message | */ |
| &completionCode, | /*Completion code | */ |
| &reason); | /*Reason | */ |

Step 208 then proceeds to step 220.

If step 204 determined that no correlation identifier was specified, in step 210, a non-destructive read request, without a specified correlation identifier, is built. For example, an application messaging interface read request is built using an amRcvBrowseSelect( ) function, but without specifying a correlation identifier. Step 210 then proceeds to step 220.

If step 202 determined that the access parameter is not equal to “READ_TABLE”, a destructive read will be performed, and processing continues to continuator A of FIG. 12B. Step 212 determines whether the SQL SELECT statement specified a correlation identifier (c_id) in a WHERE clause. If so, in step 214, the value of the correlation identifier is extracted from the message. In step 216, a destructive read request is built with the value of the correlation identifier. In one exemplary embodiment, the destructive read request is built using an application messaging interface amRcvReceive( ) function in which the service object handle, policy object handle and message object are specified as parameters. Step 216 then proceeds to step 220 of FIG. 12A (Continuator B).

If step 212 determined that the SQL SELECT statement did not specify a correlation identifier (c_id) in a WHERE clause, in step 218, a destructive read request is built without specifying a correlation identifier. Step 218 then proceeds to step 220 of FIG. 12A (Continuator B).

In step 220, the read request is executed. Step 222 determines whether any messages are available. If so, in step 224, the ampfBeginScan( ) access method purpose function allocates a buffer to store the message data. In step 226, the ampfBeginScan( ) access method purpose function moves the message data from the queue into the buffer. In step 228, ampfBeginScan( ) access method purpose function enters the allocated buffer onto a list that will be accessed by the ampNextRow( ) access method purpose function. The ampfBeginScan( ) function loops back to step 220. If step 222 determines that no messages are available, in step 230, the ampfBeginScan( ) access method purpose function exits.

FIG. 13 depicts a more-detailed flowchart of an embodiment of the ampfNextRow( ) access method purpose function. In step 232, the ampfNextRow( ) access method purpose function retrieves a buffer from the list with a message within it. In step 234, the ampfNextRow( ) access method purpose function removes the buffer that is associated with the retrieved message from the list. In step 236, the ampfNextRow( ) access method purpose function builds a row with the retrieved message data and supporting information. The ampfNextRow( ) access method purpose function returns the message data as well as an indicator that the row was successfully returned to the database engine. When no more message data is on the list, the ampfNextRow( ) access method purpose function returns a no more data indication.

FIG. 14 depicts a more-detailed flowchart of an embodiment of the ampfEndScan( ) access method purpose function. In step 238, the ampfEndScan( ) access method purpose function removes all remaining elements from the list, if any. In step 240, the ampfEndScan( ) access method purpose function deallocates any allocated memory.

Since the messaging system parameters are used to reference the messaging system configuration file, the messaging system configuration file can be changed independently of the virtual table binding. In this way, a messaging system administrator can change the operation of a queue without having to change or modify code. In another more particular embodiment, using WebSphere MQ, because the service and policy are defined in the AMT.XML file, when the service and/or policy definition changes, no code needs to be changed. The messaging system administrator changes the service or policy in the AMT.XML file.

In another embodiment, a single virtual table may be mapped to multiple message queues. In other words, a single SQL INSERT statement would send a message from one virtual table to many message queues.

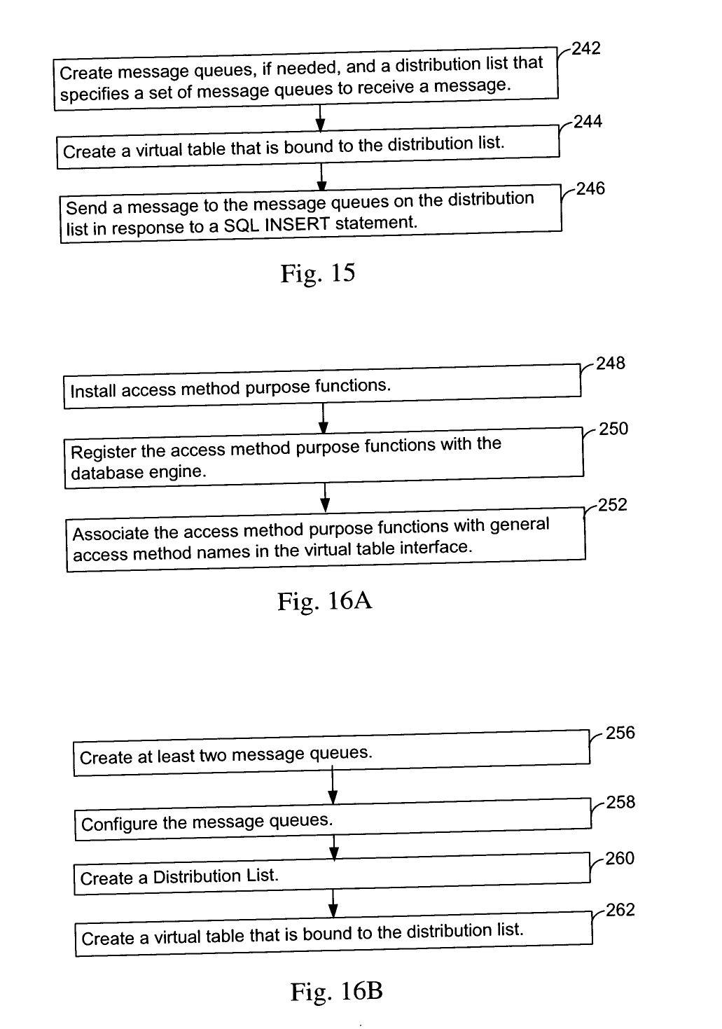

FIG. 15 depicts a high-level flowchart of an embodiment of a technique to create a distribution list, bind a virtual table to the distribution list, and send a message to the multiple message queues on the distribution list in response to a SQL INSERT statement. In step 242, the messaging system administrator creates message queues, if needed, and a distribution list that specifies a set of message queues to receive a message. In step 244, the database administrator creates a virtual table and binds the virtual table to the distribution list. In step 246, a message is sent to the message queues on the distribution list in response to a SQL INSERT statement.

FIGS. 16A and 16B depict more-detailed flowcharts of an embodiment of the technique to create a distribution list and virtual table, in which the virtual table is bound to the distribution list. Steps 248, 250 and 252 of FIG. 16A are the same as steps 130, 132 and 134 of FIG. 6A, except that the access method purpose functions also receive a distribution list name as one of the access-method-purpose-function parameters.

In FIG. 16B, in step 256, at least two message queues are created. In step 258, each message queue is configured as described with respect to step 138 of FIG. 6. In step 260, the messaging system administrator creates a distribution list. In one embodiment, the messaging system administrator provides the names of the services, policies and distribution list to the database administrator. In step 262, the virtual table is created and bound to the distribution list, such that the general access methods will be invoked in response to a SQL statement, causing the access method purpose functions to be invoked. The distribution list name will be passed as a one of the access-method-purpose-function parameters to the access method purpose functions. In this way, the virtual table is bound to multiple message queues. For example, the CreateRead( ) function is modified to bind a distribution list to a virtual table as follows:
CreateRead(‘table1 ’, ‘service1’, ‘policy1 ’, ‘DistributionListName’).

In this embodiment, the CreateRead( ) function associates the specified name of the distribution list, DistributionListName, with the virtual table name. When the CreateRead( ) function creates the virtual table with the SQL CREATE TABLE statement, the name of the distribution list is also specified as an access-method-purpose-function parameter to be passed with the policy, service, and access parameters. The access method purpose functions use the distribution list name when sending the message.

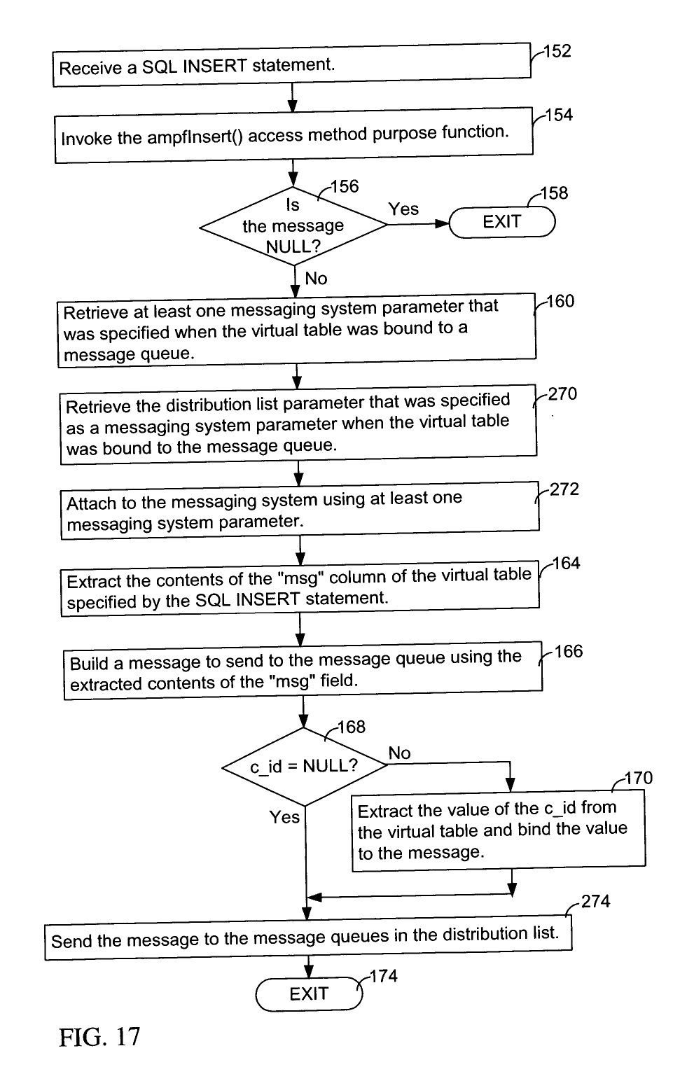

A SQL INSERT statement can now be used to send a message to the message queues in the distribution list. FIG. 17 depicts a more-detailed flowchart of an embodiment of a technique to send a message to multiple message queues in a distribution list in response to a SQL INSERT statement. FIG. 17 uses many of the same steps as FIG. 9, therefore the differences will be described. After step 160, in step 270, the access method purpose function retrieves the distribution list name that was specified and passed as an access-method-purpose-function parameter. In step 272, the access method purpose function attaches to the messaging system and creates policy, service and distribution objects. For example, a session, service object and policy object are created as described with respect to step 162 of FIG. 9. The distribution list object is created, based on the distribution list name, using the application messaging interface amSesCreateDistList function as follows:

```
amSesCreateDistList(
    hSession,
    distribution list name,
    &Completion-code,
    &Reason).
```

After steps 168 and 170, in step 274, the message is sent to the message queues in the distribution list. In one embodiment, the distribution list object is specified in the AMI send function rather than the service object. The application messaging interface will send the message to each message queue in associated with the distribution list object.

In an alternate embodiment, the CreateReceive( ) function also can be modified in a similar manner to that described above to bind a virtual table to a distribution list.

In another alternate embodiment, the CreateRead( ) function is modified to associate multiple services and policies, and therefore message queues, with a single table as follows:

```
CreateRead (‘table1.queue’, ‘service1.queue, ‘policy1.queue’,
    ‘table1.queue’, ‘service2.queue, ‘policy2.queue’,
                    ...
    ‘table1.queue’, ‘servicen.queue, ‘policyn.queue’)
```

In the CreateRead( ) function, the service and policy would be read and bound to the virtual table, and the access method purpose function would have additional AMI function calls to write to each queue.

In another alternate embodiment, multiple tables can be mapped to a single queue using multiple CreateRead( ) or CreateReceive( ) functions, as follows:

CreateRead(‘table1.queue’, ‘service1.queue’, ‘policy1.queue’)
CreateRead(‘table2.queue’, ‘service1.queue’, ‘policy1.queue’)

In the above example, both tables, table1.queue and table2.queue, would write to the same queue as specified by service1.queue.

The present invention reduces the need for a database application developer to learn about messaging system software by providing a table interface to the messaging system, thus reducing development cost and reducing the number of errors. In this way, an environment is provided in which an application developer does not know that they are interacting with a queue.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended thereto.

1. A method of interfacing a messaging system to a database management system having a table for storing data and also having at least one database command to access the table, the messaging system having at least one messaging system command to access a message queue, comprising:
accessing the message queue as a table in accordance with the database command.

2. The method of claim 1 wherein the database command is a SQL statement.

3. The method of claim 1 further comprising:
associating a virtual table with the message queue, wherein said accessing accesses the message queue through the virtual table.

4. The method of claim 3 wherein the SQL statement is a SQL INSERT statement to insert message-data in the virtual table, wherein said accessing receives the message-data from the virtual table and writes the message-data to the message queue.

5. The method of claim 3 wherein the SQL statement is a SQL SELECT statement to read message-data from the message queue and return the message-data in the virtual table.

6. The method of claim 5 wherein said read is a non-destructive read.

7. The method of claim 5 wherein said read is a destructive read.

8. The method of claim 1 wherein if the SQL SELECT statement comprises a constraint, said accessing applies the constraint when reading the message-data from the message queue.

9. The method of claim 1 further comprising associating a the virtual table with the message queue and at least one other message queue to provide a set of message queues, wherein said accessing accesses the set, comprising the message queue, in accordance with the database command.

10. An apparatus for interfacing a messaging system to a database management system having at least one database command to access a table, and the messaging system having at least one messaging system command to access a message queue, comprising:
a computer having a data storage device connected thereto, wherein the data storage device has a table for storing data; and
one or more computer programs, to be executed by the computer, for accessing the message queue as a table in accordance with the database command.

11. The apparatus of claim 10 and further comprising:
associating a virtual table with the message queue, wherein said accessing accesses the message queue through the virtual table.

12. The apparatus of claim 11 wherein the database command is a SQL SELECT statement to read message-data from the message queue and return the message-data in the virtual table.

13. The apparatus of claim 10 further comprising associating the message queue with at least one other message queue to provide a set of message queues, wherein said accessing accesses the set, comprising the message queue, in accordance with the database command.

14. An article of manufacture comprising a computer program usable medium embodying one or more instructions executable by a computer for performing a method of interfacing a messaging system to a database management system having at least one database command to access a table, the messaging system having at least one messaging system command to access a message queue, the method comprising:
accessing the message queue as a table in accordance with the database command.

15. The article of manufacture of claim 14 wherein the database command is a SQL statement.

16. The article of manufacture of claim 14 further comprising:
associating a virtual table with the message queue, wherein said accessing accesses the message queue through the virtual table.

17. The article of manufacture of claim 16 wherein the SQL statement is a SQL SELECT statement to read message-data from the message queue and return the message-data in the virtual table.

18. The article of manufacture of claim 17 wherein said read is a destructive read.

19. The article of manufacture of claim 17 wherein if the SQL SELECT statement comprises a constraint, said accessing applies the constraint when reading the message data from the message queue.

20. The article of manufacture of claim 14 further comprising associating the message queue with at least one other message queue to provide a set of message queues, wherein said accessing accesses the set, comprising the message queue, in accordance with the database command.
